(19) United States
(12) Patent Application Publication
(10) Pub. No.: US 2026/0200814 A1
(43) Pub. Date: Jul. 16, 2026

(54) FERTILIZER BIOSTIMULANT BLEND

(71) Applicant: PROFILE PRODUCTS LLC, Buffalo Grove, IL (US)

(72) Inventors: Nelson GONZALEZ, Palm City, FL (US); Brian PATTERSON, Bradenton, FL (US); Stephanie WEDRYK, Thornton, CO (US); Brandon Ellis WHITE, Ocoee, FL (US); Andrew Luis MERCADO, Palm Harbor, FL (US)

(73) Assignee: PROFILE PRODUCTS LLC, Buffalo Grove, IL (US)

(21) Appl. No.: 19/444,387

(22) Filed: Jan. 9, 2026

Related U.S. Application Data
(60) Provisional application No. 63/743,880, filed on Jan. 10, 2025.

(51) Int. Cl. C05G 3/40; C05B 17/00; C05G 5/30; C05G 5/40

(52) U.S. Cl. CPC C05G 3/40; C05B 17/00; C05G 5/30; C05G 5/40

(57) ABSTRACT

An agricultural particulate blend includes a plurality of porous, calcined clay particles having more than 50% of the particles by weight corresponding to sieve sizes 6-30 and a plurality of control release fertilizer particles in an amount of 75-99.5 wt. %, based on a total weight of the blend, the blend being a substantially homogenous blend such that the plurality of porous, calcined clay particles and the plurality of control release fertilizer particles have substantially a same size, shape, or both.

### CROSS-REFERENCE TO RELATED APPLICATIONS

This application claims priority to U.S. provisional application Ser. No. 63/743,880 filed Jan. 10, 2025, the disclosure of which is incorporated in its entirety by reference herein.

### TECHNICAL FIELD

The present disclosure relates to a biostimulant carrier material, biostimulant fertilizer blend, slow release biostimulant, and methods of making and using the same.

### BACKGROUND

To provide crops in sufficient quality and quality, various agricultural techniques have been implemented from fertilization to application of pesticides. Yet, new methods are needed to compensate for growing food demand, soil damage, and nutrient depletion.

### SUMMARY

In one embodiment, an agricultural particulate blend is disclosed. The blend includes a plurality of calcined clay particles and a plurality of control release fertilizer particles.

In one or more embodiments, an agricultural particulate blend is disclosed. The blend includes a plurality of carrier particles, each particle having a porous matrix, and a plurality of control release fertilizer particles, the carrier particles having a composition comprising a compound.

In another embodiment, an agricultural particulate blend is disclosed. The blend includes a plurality of porous particles coated with a water-soluble biostimulant composition and a plurality of control release fertilizer particles.

In yet another embodiment, a slow release biostimulant is disclosed. The biostimulant includes a carrier matrix having a plurality of pores and a biostimulant composition arranged in the plurality of pores. The biostimulant may be water-soluble. The biostimulant may be arranged on an outer surface of the matrix. The carrier matrix may include calcined clay. The biostimulant may be a slow-release composition with a predetermined release rate. The biostimulant may be included in an amount of about 1-30 lbs per 100 lbs of the plurality of carrier particles. The slow release biostimulant may further include at least one layer of a sealing material. The sealing material may include a drying oil, wax, or both.

In one or more embodiments, an agricultural particulate blend is disclosed. The blend includes a plurality of porous, calcined clay particles having more than 50% of the particles by weight corresponding to sieve sizes 6-30; and a plurality of control release fertilizer particles in an amount of 75-99.5 wt. %, based on a total weight of the blend, the blend being a substantially homogenous blend such that the plurality of porous, calcined clay particles and the plurality of control release fertilizer particles have substantially a same size, shape, or both. A relative size ratio of the control release fertilizer particles to the calcined clay particles may be about 0.75:1 to 1:0.75. The plurality of porous, calcined clay particles may include spherical particles. The plurality of porous, calcined clay particles may include angular particles. The calcined clay particles may include a biostimulant compound. The blend may include two different types of control release fertilizer particles, each type having a different NPK ratio. The control release fertilizer particles may have NPK ratio of 16-5-7. About 12-35 wt. % of the calcined clay particles may correspond to sieve size 8.

In another embodiment, an agricultural particulate blend is disclosed. The blend includes a plurality of carrier particles, each particle having a porous matrix and a water-soluble compound sorbed to the porous matrix; and a plurality of control release fertilizer particles in an amount of about 75-99.5 wt. %, based on a total weight of the blend, the blend being a substantially homogenous blend such that the plurality of carrier particles and the plurality of control release fertilizer particles have substantially a same size, shape, or both. The water-soluble compound may include a biostimulant. The water-soluble compound may form an outer layer of the carrier particles. The porous matrix may include a pore filled with the water-soluble compound. The water-soluble compound may be included in an amount of about 1-60 lbs per 100 lbs of the plurality of carrier particles. The plurality of carrier particles may include calcined clay particles. The water-soluble compound may include a slow-release biostimulant composition with a predetermined release rate.

In yet another embodiment, an agricultural particulate blend is disclosed. The blend includes a plurality of carrier particles, each particle having a porous matrix; a water-soluble compound sorbed to the porous matrix; and a sealing material forming an outer layer of each particle; and a plurality of control release fertilizer particles, the blend being a substantially homogenous blend such that the plurality of carrier particles and the plurality of control release fertilizer particles have substantially a same size, shape, or both. The water-soluble compound may include a biostimulant. The sealing material may include a drying oil. The sealing material may be included in an amount of about 1-30 lbs per 100 lbs of the plurality of carrier particles. The porous matrix may include calcined clay.

### BRIEF DESCRIPTION OF THE DRAWINGS

FIG. 1 is a schematic depiction of a particulate carrier matrix with a number of pores;

FIG. 2 is a schematic depiction of a blend of carrier particles and control release fertilizer (CRF) particles;

FIGS. 3 and 4 are photographs of non-limiting example blends of carrier particles and control release fertilizer particles;

FIG. 5 is a graph of release curves for Examples 5-8; and

FIG. 6 is a graph of release curves for Examples 9 and 10.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the disclosure can be obtained within a range of +/−5% of the indicated value. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . , 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. Similarly, whenever listing integers are provided herein, it should also be appreciated that the listing of integers explicitly includes ranges of any two integers within the listing.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A,” the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Also, the description of a group or class of materials as suitable for a given purpose in connection with one or more embodiments implies that the group or class of materials can “comprise,” “consist of,” and/or “consist essentially of” any member or the entirety of that group or class of materials. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Modern agricultural techniques have utilized various substances to increase yields, minimize damage by pests, and increase resistance of plants to various diseases. At the same time, modern agricultural techniques have contributed to a plethora of new challenges such as soil compaction due to heavy machinery, overuse of soil leading to nutritional depletion, and soil treatments leading to damage of the soil microbiome. Additionally, a traditional use of N—P—K (nitrogen-phosphorus-potassium) fertilizers has been suggested to cause decreasing concentrations of elements such as iron (Fe), zinc (Zn), copper (Cu), magnesium (Mg), and other trace elements in foods.

As a result, it is becoming increasingly difficult, technically and economically, to grow agricultural plants and provide food with sufficient nutritional value. At the same time, the world population is increasing and demand for food is growing. Therefore, there is a need to improve health and quality of the soil and in turn, provide sufficient nutrients to the plants.

In one or more embodiments, a carrier is disclosed. The carrier may include a number of 3-dimensional structures of any form, shape, or size. In a non-limiting example, the carrier may include a plurality of particles. The particles may be the same, different, irregular, regular, symmetrical, asymmetrical, or a combination thereof. The particles may be angular, spherical, or the like. The particle may have a substantially round cross-section.

The particles may include a porous material. The porous material may include clay, zeolite, sand, porous silica, diatomic silica, ceramics, mineral silica sources, volcanic deposits, granulated materials, biopolymers, molecular sieves, leonardite, lignite, activated carbon, aluminum phosphates, diatomaceous earth, or their combination. The clay may include calcium montmorillonite clay, montmorillonite, beidellite, nontronite, hectorite, saponite, attapugite, sepiolite, opal CT (cristobalite, tridymite), sodium bentonite, kaolin, aluminosilicate minerals, non-processed fine-grained hydrous aluminum phyllosilicates or clay minerals, or their combination. The volcanic deposits may include feldspar, quartz polymorphs, muscovite, olivine, pyroxene, stilbite, stellerite, barrerite, volcanic rock, pumice, the like, or their combination. The zeolites may be natural or synthetic. The granulated material may include granulated biochar, peat, mill mud, the like, or their combination. The molecular sieves may include octahedral molecular sieves.

In a non-limiting example, the carrier particles may include silica (SiO₂), alumina (Al₂O₃), iron oxide (Fe₂O₃), calcium oxide (CaO), magnesium oxide (MgO), potassium oxide (K₂O), sodium oxide (Na₂O), titanium oxide (TiO₂), the like, or their combination.

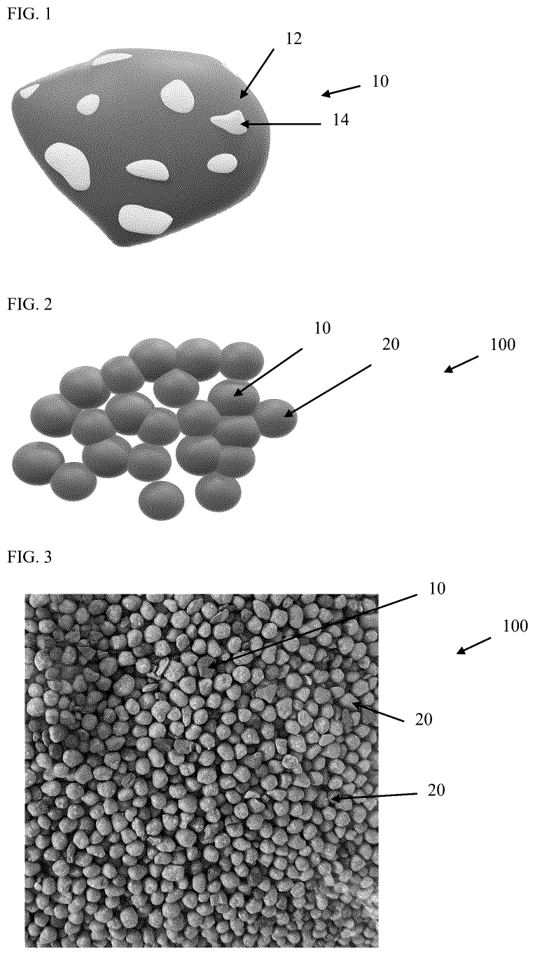

The porous material may form a matrix having a plurality of micro spaces or micrometer scale pores within the topography of the material. The particle surface may thus be irregular with protrusions and indentations, valleys, dips, which serve as a housing for any material the carrier is configured to carry. A non-limiting schematic example depiction of a carrier particle 10 with porosity is shown in FIG. 1, where 12 represents the body of the particle and 14 depicts pores.

In a non-limiting example, the carrier particles include clay containing about 5-60%, 10-50%, or 20-35% of montmorillonite and about 40-90%, 30-80%, or 45-60% opal CT, respectively, with varying content of quartz, other clays, minerals, and impurities, as measured by x-ray diffraction. The carrier particles include clay containing about 25-30% montmorillonite, about 2-7% quartz, and about 50-60% opal CT, as measured by x-ray diffraction.

The porous material such as the clay may be thermally processed such as by calcining. The clay may be calcined at a temperature of about 1000 to 1400, 1100 to 1350, or 1200 to 1300° F. The calcination process may result in modification of at least some of the materials into minerals. A non-limiting example of a calcined particle may include about 1-2% montmorillonite, about 20-30% illite, about 2-5% quartz, and about 40-50% opal CT, as measured by X-ray diffraction, Fourier Transform Infrared Spectroscopy, or the like.

The calcining process generates particles having a variety of sizes. Additional processes such as screening or sieving may be implemented to arrive at desirable particles sizes. The carrier particle formation process may include sizing or micronizing by grinding. The carrier particles are thus calcined, sieved, and sized particles. The carrier material such as the calcined clay is non-soluble in water.

It is desirable that the carrier is configured such that the carrier particles have a relatively large surface area and good suspension in liquid. The large surface area may be achieved by providing particles whose surface is not smooth but relatively course or rough. The large surface area may relate to about, at least about, or at most about 40 to 85, 45 to 80, or 50 to 75 m²/g. The large surface area may relate to about, at least about, or at most about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, or 85 m²/g.

The carrier may include a mixture of different sizes of the carrier particles. Non-limiting example sizes of the carrier particles may correspond to the sieve sizes in the range of 5 to 30, 8 to 16, 10 to 50, 24 to 48, or the like. Non-limiting example particle distributions are shown in Table 1 below.

The carrier particles may include most or majority of particles corresponding to sieve sizes 6-30. The most or majority refers to about 50 including 49 wt. % or more, based on weight of all carrier particles. The most or majority of the particles corresponding to sieve sizes 6-30 may include sieve sizes 6, 8, 10, 12, 16, 20, and 30. The remainder of the particles may correspond to the sieve sizes above 30 such as sieve sizes 40, 50, or 60.

A non-limiting average clay particle size after grinding may be about 0.30 to 4.00, 0.6 to 3.36, or 0.8 to 2.83 mm. The average carrier particle size may be about, less than about, more than about, or at least about 0.3, 0.4, 0.5, 0.6, 0.7, 0.8. 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.0 mm, or any range including any two numerals disclosed herein. The size may refer to one or more of length, width, diameter, perimeter, or the like.

TABLE 1
Particle distribution of carrier particles of Examples 1-4

| Sieve size | Example 1 | Example 2 | Example 3 | Example 4 | Range 1 | Range 2 |
|---|---|---|---|---|---|---|
| #/mm | [wt. %] | [wt. %] | [wt. %] | [wt. %] | [wt. %] | [wt. %] |
| 5/4.00 | 1.6 | — | — | — | 0-3 | 0.5-2.75 |
| mm | | | | | | |
| 6/3.36 | 10.4 | — | — | — | 0-15 | 0.5-12 |
| mm | | | | | | |
| 8/2.38 | 34.0 | — | 13.1 | — | 10-40 | 12-35 |
| mm | | | | | | |
| 10/2.00 | — | 0.3 | — | — | 0-1 | 0.25-0.8 |
| mm | | | | | | |
| 12/1.68 | 28.5 | — | — | — | 15-45 | 20-35 |
| mm | | | | | | |
| 16/1.19 | — | — | 84.7 | — | 0-95 | 40-90 |
| mm | | | | | | |
| 20/0.84 | 25.0 | 55.8 | 2.0 | 1.5 | 1-65 | 1.5-60 |
| mm | | | | | | |
| 30/0.60 | 0.3 | 23.4 | — | 47.7 | 0-60 | 0.25-50 |
| mm | | | | | | |
| 40/0.42 | — | — | — | 40.0 | 0-50 | 0.5-45 |
| mm | | | | | | |
| 50/0.30 | 0.1 | 20.2 | 0.1 | 10.4 | 0-25 | 0.1-22 |
| mm | | | | | | |
| 60/0.25 | — | — | — | 0.3 | 0-1 | 0.3-0.8 |
| mm | | | | | | |
| Pan/ | 0.1 | 0.3 | 0.1 | 0.1 | 0.08-0.8 | 0.1-0.5 |
| below 0.25 | | | | | | |
| mm | | | | | | |

The carrier particles' resistance to attrition (RTA) may be about 85 to 97, 86 to 96, or 87 to 95%.

The carrier particles may include one or more layers of different material(s). The one or more layers may include 1, 2, 3, 4, 5, 6, 7, 8, 9, 10, or more layers. The one or more layers may have the same or different properties such as the same material amount, thickness, density, the like, or their combination. In a non-limiting example, each layer may include the same amount of material. In another non-limiting example, all the layers may include the same type of material regarding chemical composition.

Each layer may include the same or different amount of the material. For example, the amount of material deposited to the carrier particle may be uniform or non-uniform. The non-uniform manner may relate to a thickness of the material such that a greater amount of the material may be deposited in undulations, dips, valleys of the carrier than the rest of the surface of the carrier particle. As a result, the material may equalize non-uniformity of the particle shape and/or surface. As a result, the particle may have substantially round shape, substantially circular cross-section, or both. In other embodiments, the carrier particle includes the deposited material and retains the undulations and non-uniform surface.

In one or more embodiments, the material may include a sealing material such as a drying oil. A drying oil is a fluid that, when exposed to air, hardens into a solid, flexible film due to polymerization, which involves the drying oil reacting with oxygen and crosslinking. The sealing material may enable retention of one or more compounds within the carrier particles for a predetermined amount of time and gradual, slow, or predetermined release of the one or more compounds from the carrier particles.

The drying oil may include unsaturated fatty acids (one double bond is present), glycerols, triglycerols, the like, or their combination. The drying oil may include linseed oil, tung oil, soybean oil, epoxidized soybean oil, poppy seed oil, perilla oil, castor oil, dehydrated castor oil, coconut oil, tall oil, walnut oil, or their combination.

The sealing material may also, or alternatively, include a wax such as organic, paraffin wax, or the like. The wax may be applied as a top-most, outer layer over the water-soluble compound or over the drying oil.

In another embodiment, the material may include a natural organic or mineral functional materials. The material may include biogenic, plant-derived, carbon-based substances such as starch, celluloses, hemicelluloses, gums, sugars, lignosulfonates, humic acid, fulvic acid, molasses, or their combination. The material may include inorganic, mineral-based substances such as silicate materials (clay, zeolite, silica), limestone (CaCO₃), dolomite (CaMg(CO₃)₂), calcium sulfate (CaSO₄, gypsum), or their combination.

The carrier may be configured as a base for a composition. The carrier may function as a sorbent for the composition. The sorbent may be an absorbent or adsorbent. The composition may be a blend of one or more components. The components may include one or more fluids, liquids, gels, or their combination. The components may include water, one or more water-based or water-soluble compounds, biostimulants, pesticides, insecticides, fungicides, fertilizers, or their combination. The components may additionally include a binder, surfactant, the like, or their combination.

While the carrier may hold the one or more components, the material, such as the drying oil, may enable holding of the components within the carrier for a longer period and releasing them in time, thus causing a slow release of components such as biostimulants. In a non-limiting example, the drying oil is applied onto the carrier and dried on the carrier. The drying oil is combined with one or more biostimulants, for example by the biostimulants being applied onto the porous surface of the carrier particles. The carrier thus includes biostimulants which are soaked into the carrier material and a layer of drying oil is applied over the carrier material. The same concept is applicable to additional components named herein such as water-soluble nutrients such as N, P, K, Si, Se, Co, Ti, the like, or their combination.

Biostimulants may include any substance or microorganism that, when applied to seeds or plants, stimulates natural processes to enhance or benefit nutrient uptake, nutrient use efficiency, plant growth, crop quality and yield, mitigate stress, or their combination. The application may be directly via foliar applications or indirectly through soil/soil-less media. Biostimulants may include many different types. Non-limiting example biostimulants include enzymes, proteins, amino acids, peptides, protein hydrolysates, and/or other N-containing compounds, micronutrients such as Ca, Al, Co, Na, Se, Si, phenols, salicylic acid, monosilicic acid, polysilicic acids, humic acid, fulvic acid, seaweed extract, botanicals, biopolymers such as chitosan, inorganic compounds such as amorphous silica (SiO₂.nH₂O), silicates such as potassium silicate, calcium silicate, microbial biostimulants including mycorrhizal and non-mycorrbizal fungi, bacterial endosymbionts (like Rhizobium) and Plant Growth-Promoting Rhizobacteria, fungi, fish oil, extracts including plant-based extracts, animal-based extracts, or both, etc.

The biostimulants may include different classes of biostimulants. The classes may differ by chemical composition, physical properties, type of effect on the soil, plants, or both, or their combination.

The biostimulants may be water-soluble biostimulants. The water-soluble biostimulants may include protein hydrolysates, amino acids, peptides, enzymes, seaweed extract such as Ascophyllum nodosum or Ecklonia maxima, fulvic acid, humic acid, vitamins-vitamin C, B vitamins, organic acids including carboxylic acid such as citric or gluconic acids, sugars including simple sugars such as glucose and polysaccharides, microalgae extracts, algal extracts, plant extracts such as alfalfa extracts, corn steep liquor, or their combination. In a non-limiting example, the biostimulants may include a combination of fulvic acid and/or humic acid. In another non-limiting example, the biostimulants may include a combination of amino acid(s) and organic acid(s). In another non-limiting example, the biostimulants may include polysaccharide(s) and microalgae extract.

Pesticides are substances or mixtures of substances used to kill, repel, or control pests, such as insects, rodents, fungi, weeds, and microorganisms. Pesticides may include insecticides, fungicides, herbicides, the like, or their combination.

Insecticides are chemical substances used to control insects by killing them or preventing them from engaging in crop undesirable or destructive behaviors. The insecticides may act upon the insect's nervous system, damaging the exoskeleton, growth regulators, endotoxins, or their combination. The insecticides may include one or more classes of insecticides. The insecticides may include organochlorines, organophosphates, organosulfur, carbamates, formamidines, dinitrophenols, organotins, pyrethroids, nicotinoids, spinosyns, pyrazoles, pyridazinones, quinazolines, botanicals, synergists/activators, antibiotics, fumigants, inorganics, biorational, benzoylureas, the like, or their combination. The insecticides may include sustainable insecticides such as oils including neem oil, canola oil, mint, red chili pepper, plant extracts such as pyrethrin, or the like.

Fungicides are substances and materials that kill or prevent the growth of fungi and/or their spores. Fungicides may block a specific metabolic pathway in the fungus which prevents spore germination or hyphal growth. Fungicides may prevent or minimize mold, mildew, rusts, blights. Fungicides may be organic or inorganic. Fungicides may include copper salts, sulfur salts, oils such as neem oil, rosemary oil, jojoba oil, the bacterium Bacillus subtilis, the beneficial fungus Ulocladium oudemansii, extracts from plants such as chamomile, cinnamon, apple cider vinegar, or their combination.

Herbicides are substances used to control or minimize undesirable vegetation. Herbicides may include amino-acid inhibitors, photosynthesis inhibitors, synthetic auxin, growth regulators, cell division inhibitors, or their combination. The herbicides may be sustainable such as based on clove oil, citric acid, or acetic acid. The herbicides may be bioherbicides such as plant-based, microbial, or made from recycled microalgae biomass.

Liquid nutrients may include liquid sources of nutrients such as nitrogen (N), phosphorus (P), potassium (K), calcium (Ca), sulfur(S), magnesium (Mg), boron (B), zinc (Zn), manganese (Mn), iron (Fe), copper (Cu), molybdenum (Mo), chlorine (CI), nickel (Ni), the like, or their combination. The liquid nutrients may include urea, urea ammonium nitrate (UAN), ammonium nitrate, or other nitrogen-containing compounds, phosphoric acid or superphosphate, potassium chloride or potassium sulfate, chelated forms of minerals. Chelates may include EDTA, EDDHA, or the like. Non-limiting example NPK ratios may include 1-1-1, 2-1-1, 1-2-2, 1-2-1, Oct. 10, 2010, 20-5-5, May 10, 2010, or the like.

The composition may be incorporated onto, into, within the carrier, or a combination thereof. The composition may be included on the surface of the carrier, in the pores of the carrier, or both. For example, the composition may penetrate into the pores of the material, coat the surface of the pores, fill the volume of the pores, or their combination. The composition may coat the outer surface of the carrier, inner surface of the carrier, or both. The surface may be the entire surface or one or more portions of the surface.

The structure of the carrier may retain the composition and release it over time. The retention may be due to chemical interactions, steric effects, or both. The retention of the composition may be configured to cause a predetermined release of the composition over time. The carrier with the composition may be thus a slow release or control release composition such as a slow release or control release biostimulant.

The carrier, with or without the composition, may be combined with a particulate fertilizer to form a blend. The particulate fertilizer may be in a solid or gel form such as granular form, prills, agglomerations, clusters, or the like. The particulate fertilizer may include a plurality of the granules or prills having the same or different shape, size, composition, configuration, or a combination thereof. The shape may be generally round, oval, angular, regular, or irregular. The particulate fertilizer prills may be approximately the same size and weight as the particulate fertilizer prills in the blend, as the carrier particles, or both. A non-limiting schematic depiction of the blend 100 is shown in FIG. 2. The blend includes a mixture of carrier particles 10 and CRF particles 20.

The fertilizer may be a slow release or control release fertilizer (CRF). CRFs, also called controlled-availability fertilizers, delayed-release fertilizers, or slow-acting fertilizers, have been developed to address environmental and economical issues associated with traditional liquid fertilizers. The particulate fertilizer may include a coating enabling the slow or control release. The coating may have one or more layers, each layer having the same or different composition. The coating may be biodegradable, cellulose-based, polyethylene-based, polyurethane-based, or the like. The coating functions as a semi-permeable membrane.

The fertilizer may include a nutritional core encased by the coating. The nutritional core may include a single type of nutrient or a mixture of macronutrient, micronutrients, or both. The core may include one or more compounds including the nutrients. The core may include a substrate fertilizer. Non-limiting example substrates may include ammonium sulfate, ammonium chloride, ammonium nitrate, urea, potassium chloride, potassium sulfate, potassium nitrate, sodium nitrate, ammonium phosphate, potassium phosphate, calcium phosphate, and composite fertilizers thereof.

The combination nutrient core may include N, P, K in various ratios. Non-limiting example NPK weight ratios may include 21-7-14, 15-15-15, 19-6-12, 12-0-46, 3-1-2, 6-2-4, 9-3-6, 17-5-11, 16-16-16, 16-5-7, 10-10-10, 14-4-14, 5-1-31, 5-1-30, 5-1-25, 4-1-16, 3-1-12, 3-0-15, 2-1-4, 1-0-31, 1-0-8, 1-0-3, 1-0-2, 44.5-0-0, 43-0-0, or the like. In at least some embodiments, the NPK ratio may have a high K to low N ratio such as 8:1-2:1, 7:1-3:1, or 6:1-4:1 such as 5-1-30, 5-1-31, 5-1-30, 5-1-25, 4-1-16, 3-1-12, 3-0-15, 2-1-4, 1-0-31, 1-0-8, 1-0-3, 1-0-2, 0-0-19, 0-0-22, 0-0-037, 0-0-047, 1-0-30, 1-0-31, 2-0-35, 2-0-38, 14-4-14, 17-5-11, 18-6-8, 18-0-0, or the like.

Additionally or alternatively, the core may include minerals such as Ca, S, Mg, B, Zn, Mn, Fe, Cu, Mo, Cl, Ni, or their combination.

The fertilizer prills in the blend may all have the same chemical composition. Alternatively, the fertilizer prills may have different chemical composition of the core, coating, or both. In a non-limiting example, the prills may have two different types of NPK ratios. In another non-limiting example, a first type of particulate fertilizer may have a urea core and a second type of particulate fertilizer within the same blend may have an NPK core.

The activation of the nutrient release from the fertilizer particles may be initiated by ingress of water, change in humidity, change in temperature, or their combination. When a sufficient amount of water enters the fertilizer prill via the coating, the water reaches the nutrients in the nutrient core. The nutrients are carried by the water via the internal and/or external coatings out to the target. The release rate, abrasion resistance, robustness of the coatings, coating weight, and other properties discussed below, influence quantity and rate of nutrients being carried out.

The particulate fertilizer may be granulated, granular fertilizer including fertilizer particles. The particles may be granules, pellets, or other particles. The particles may be substantially uniform. For example, the fertilizer may include one or more sizes of the particles with the average size being about 50 to 350 sgn (0.5 to 3.5 mm), 100 to 300 sgn (1 to 3 mm), or 150 to 280 sgn (1.5 to 2.8 mm). The fertilizer particle average size may be about, at least about, or at most about 0.5, 0.6, 0.7, 0.8. 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5 mm. The size may refer to one or more of length, width, diameter, perimeter, or the like.

The fertilizer may have high uniformity of the particles such that about or at least about 50, 55, 60, 65, 70, 75, 80, 85, 90, 95, or more weight % of the fertilizer, based on the total weight of the fertilizer, has substantially the same size of particles. As such, the fertilizer may have low variance in size or low fluctuation of sizing.

The carrier particles and the fertilizer particles within the blend have substantially the same shape, average size, color, particle distribution, texture, or their combination. Such blend may be called a homogenous blend, referring to a blend being substantially uniform regarding at least one property named herein. In a non-limiting example, the carrier particles and the fertilizer particles have different color, but substantially the same shape. In another non-limiting example, the carrier particles and the fertilizer particles have substantially the same size. The term “substantially,” as referred to herein, means within 5 to 10% of the relevant property. For example, the carrier particles and the fertilizer particles of the blend may each have an average particle size x with a deviation of +−5% of the x. Alternatively, the carrier particles may be predominantly angular and less spherical than the fertilizer particles.

Relative size ratio of the fertilizer particles to the carrier particles may be about 0.75:1 to 1:075, 0.8:1 to 1:0.8, 0.9:1 to 1:0.9, or 1:1. The size ratio refers to diameter or length of the particles.

The advantage of substantially the same size of the particles within the blend may enable relatively uniform distribution of the carrier and the fertilizer particles within storage containers such as bags. Additionally, substantially similar size may enable smoother operation of the hopper and other equipment handling the blend.

The blend may include the fertilizer particles with the carrier particles. The carrier particles may include only or consist only of the matrix material. The matrix material may function as a water absorption matrix such that water holding capacity of the blend is increased. Alternatively, at least some or all of the carrier particles may include a composition such as one or more of a water, biostimulant, pesticide, etc.

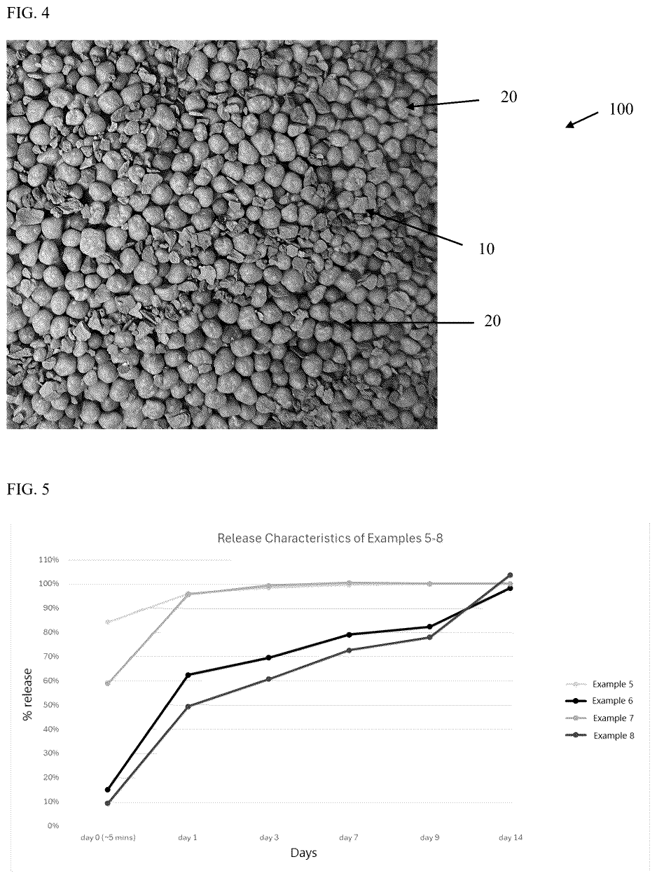

The particulate blend may be a blend suitable for agriculture, horticulture, floriculture, hydroponic use, sustainable cultivation, the like, or their combination. Non-limiting examples of the blend are shown in FIGS. 3 and 4, which depict a blend 100 having carrier particles 10 with particle distribution of Example 1 and CRF particles 20 with two different NPK ratios (18-6-8 depicted as dark and 17-5-11 depicted as light rounded particles).

A method of producing the disclosed particles and blend is disclosed herein. The method may include producing the carrier particles. The method may include calcining the carrier raw material such as clay, sizing the particles, sorting the particles, or their combination.

The method may include providing the carrier particles with one or more compounds such as a fertilizer, pesticide, insecticide, or their combination. The providing may include including the compound(s) as a liquid and by weight, for example by spraying, dipping, soaking, sparging, or otherwise applying the one or more compounds onto and/or into the carrier. The providing may be done once or repeatedly. In a non-limiting example, the compound(s) may be added as a solid stream through a pump delivery system. The amount of the compound(s) applied to the carrier may be about 1-60, 5-50, or 10-40 lbs of material per 100 pounds of carrier.

The method may also include adding a material to seal the compound(s) within the carrier particles. The method may include adding one or more layers of a sealing material such as oil. The material may be added in an amount of about 1-30, 5-25, or 10-20 lbs of material to 100 lbs of carrier.

The method may include forming the fertilizer particles. The method may include providing a coating onto a nutrient core to form individual fertilizer particles. The method may include mixing fertilizer particles having different chemical compositions of the coating, core, or both. The method may thus include forming a pre-blend of fertilizer particles. The fertilizer particle may include slow release fertilizer, control release fertilizer, the like, or their combination.

The method may include combining an equal or unequal amounts of the carrier particles and fertilizer particles to form the blend. The method may include sorting the particles by size, shape, color, volume, weight, or their combination. The method may include forming a blend having a ratio of the carrier particles to the fertilizer particles. The ratio may be about 1:1, 1:1.5, 1:2, 1:2.5, 1:3, 1:4, 1:5, 1:6, 1:7, 1:8, 1:9, 1:10, or vice versa by weight or volume %, based on the total weight or volume of the blend. The amount of carrier particles in the blend may be about 0.5-25, 5-20, or 10-15 wt. %, based on the weight of the blend. The amount of the carrier particles may be about 0.5, 1, 2, 3, 4, 5, 6, 7, 8, 9, 10, 11, 12, 13, 14, 15, 16, 17, 18, 19, 20, 21, 22, 23, 24, or 25 wt. %, based on the weight of the blend. The fertilizer particles represent about 75 to 99.5, 80 to 95, or 85 to 90 wt. %, based on the total weight of the blend.

The blend may provide beneficial nutrients to the soil and/or plant at different stages of the planting process and growing season. For example, the carrier particles themselves may be beneficial as a subdress in a field application, as a soil amendment configured to add cation exchange capacity into sandy soils, as a medium to increase or maintain water holding capacity, or the like.

The blend may release a composition such as a biostimulant to boost the soil health or microbiome of the soil. The blend may release a composition such as an oil acting as a pesticide, insecticide, fungicide, etc.

The blend may further release nutrients to the plant during different stages of the plant growth, for example K during the flowering stage. The blend may release the same nutrients throughout the growing season such as N. Additionally, the blend may result in benefits for plant growth such as root growth, increase ability to tolerate stressful conditions such as nutrient deficiency, moisture, salinity, temperature stress, or the like.

### EXAMPLES

### Example 1-4

Four blends of carrier particles of Examples 1-4 having particle distribution shown in Table 1 above and NPK particles was formed. The carrier particles included calcined clay particles having porous surfaces. The NPK included 16-5-7 particles. The blends were bagged, distributed via traditional machinery, and applied onto plants.

### Examples 5-8

Carrier particles including calcined clay of Examples 1 and 4 were tested for release characteristics. Example 5 included calcined clay particles of Example 4 without any additional material, Example 6 included calcined clay particles of Example 4 with a coating of epoxidized soybean oil, Example 7 included calcined clay particles of Example 1, and Example 8 included calcined clay particles of Example 1 with a coating of epoxidized soybean oil. Examples 6 and 8 were air dried for up to 14 days after application of the oil onto their surface.

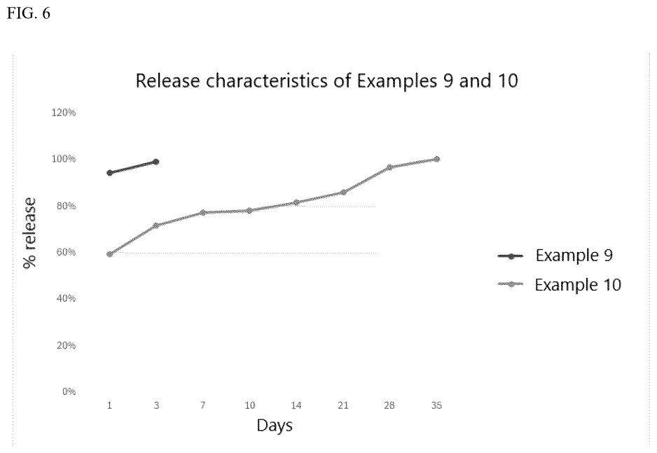

A soak test was performed on examples 5-8, where clay particles were soaked in distilled water at ambient temperature to measure electrical conductivity (EC), i.e. salts released from the clay. To perform soak tests, 15 grams of clay particles were added to 150 ml of distilled water and EC readings were taken incrementally. The particles of Example 5-8 were soaked with water and the release of water from the particles was observed. The release curve is shown in FIG. 5 and the data is provided in Table 2 below.

TABLE 2
Release data for Examples 5-8

| | % of release [%] | | | | |
|---|---|---|---|---|---|
| Day | Example 5 | Example 6 | Example 7 | Example 8 | Total |
| 0 (5 min) | 84 | 15 | 59 | 9 | 42 |
| 1 | 96 | 62 | 96 | 49 | 76 |
| 3 | 98 | 69 | 99 | 61 | 82 |
| 7 | 100 | 79 | 100 | 73 | 88 |
| 9 | 100 | 82 | 100 | 78 | 90 |
| 14 | 100 | 98 | 100 | 104 | 100 |
| Total | 96 | 68 | 92 | 62 | 80 |

### Examples 9 and 10

The release characteristic was further evaluated using carrier of Example 1 soaked with a nutrient solution. Example 9 included calcined clay particles of Example 1 with a nutrient soaked into the carrier, and Example 8 included calcined clay particles of Example 1 with a nutrient solution and further including a coating of epoxidized soybean oil. The release characteristics of the nutrient from the particles of Examples 9 and 10 are shown in Table 3 and FIG. 6.

TABLE 3
Release data for Examples 9 and 10

% of release [%]

| Day | Example 9 | Example 10 |
|---|---|---|
| 1 | 94 | 59 |
| 3 | 99 | 72 |
| 7 | 100 | 77 |
| 10 | 100 | 78 |
| 14 | 100 | 81 |
| 21 | 100 | 86 |
| 28 | 100 | 97 |
| 35 | 100 | 100 |

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. An agricultural particulate blend comprising:
a plurality of porous, calcined clay particles having more than 50% of the particles by weight corresponding to sieve sizes 6-30; and
a plurality of control release fertilizer particles in an amount of 75-99.5 wt. %, based on a total weight of the blend,
the blend being a substantially homogenous blend such that the plurality of porous, calcined clay particles and the plurality of control release fertilizer particles have substantially a same size, shape, or both.

2. The blend of claim 1, wherein a relative size ratio of the control release fertilizer particles to the calcined clay particles is about 0.75:1 to 1:0.75.

3. The blend of claim 1, wherein the plurality of porous, calcined clay particles includes spherical particles.

4. The blend of claim 1, wherein the plurality of porous, calcined clay particles includes angular particles.

5. The blend of claim 1, wherein the calcined clay particles include a biostimulant compound.

6. The blend of claim 1, wherein the blend includes two different types of control release fertilizer particles, each type having a different NPK ratio.

7. The blend of claim 1, wherein the control release fertilizer particles have NPK ratio of 16-5-7.

8. The blend of claim 1, wherein about 12-35 wt. % of the calcined clay particles correspond to sieve size 8.

9. An agricultural particulate blend comprising:
a plurality of carrier particles, each particle having a porous matrix and a water-soluble compound sorbed to the porous matrix; and
a plurality of control release fertilizer particles in an amount of about 75-99.5 wt. %, based on a total weight of the blend,
the blend being a substantially homogenous blend such that the plurality of carrier particles and the plurality of control release fertilizer particles have substantially a same size, shape, or both.

10. The blend of claim 9, wherein the water-soluble compound includes a biostimulant.

11. The blend of claim 9, wherein the water-soluble compound forms an outer layer of the carrier particles.

12. The blend of claim 9, wherein the porous matrix includes a pore filled with the water-soluble compound.

13. The blend of claim 9, wherein the water-soluble compound is included in an amount of about 1-60 lbs per 100 lbs of the plurality of carrier particles.

14. The blend of claim 9, wherein the plurality of carrier particles includes calcined clay particles.

15. The blend of claim 9, wherein the water-soluble compound includes a slow-release biostimulant composition with a predetermined release rate.

16. An agricultural particulate blend comprising:
a plurality of carrier particles, each particle having
a porous matrix;
a water-soluble compound sorbed to the porous matrix; and
a sealing material forming an outer layer of each particle; and
a plurality of control release fertilizer particles,
the blend being a substantially homogenous blend such that the plurality of carrier particles and the plurality of control release fertilizer particles have substantially a same size, shape, or both.

17. The blend of claim 16, wherein the water-soluble compound includes a biostimulant.

18. The blend of claim 16, wherein the sealing material includes a drying oil.

19. The blend of claim 16, wherein the sealing material is included in an amount of about 1-30 lbs per 100 lbs of the plurality of carrier particles.

20. The blend of claim 16, wherein the porous matrix includes calcined clay.
